(19) United States
(12) Patent Application Publication
(10) Pub. No.: US 2018/0187063 A1
(43) Pub. Date: Jul. 5, 2018

(54) Conductive Weighting Agents and Fluids Incorporating The Same

(71) Applicant: M-I L.L.C., Houston, TX (US)

(72) Inventors: Brandi Katherine Price Hoelscher, Houston, TX (US); James Friedheim, Spring, TX (US)

(21) Appl. No.: 15/580,683

(22) PCT Filed: Nov. 10, 2015
(86) PCT No.: PCT/US2015/059876

§ 371 Date: Dec. 7, 2017

Related U.S. Application Data
(60) Provisional application No. 62/173,293, filed on Jun. 9, 2015.

(51) Int. Cl. C09K 8/36; C09K 8/34; E21B 49/00; E21B 21/00

(52) U.S. Cl. CPC C09K 8/36; C09K 8/34; E21B 49/003; E21B 7/04; E21B 21/003; E21B 49/005; E21B 21/00

(57) ABSTRACT

Wellbore fluid compositions and methods of drilling a wellbore are disclosed. Wellbore fluids for drilling wellbores include a base fluid and a conductive

### CROSS-REFERENCE TO RELATED APPLICATION

The present application claims the benefit of, and priority to, U.S. Provisional Patent Application No. 62/173,293, filed Jun. 9, 2015, which is hereby incorporated by reference in its entirety.

### BACKGROUND

When drilling or completing wells in earth formations, various fluids typically are used in the well for a variety of reasons. Common uses for wellbore fluids include: lubrication and cooling of drill bit cutting surfaces while drilling generally or drilling-in (i.e., drilling in a targeted petroliferous formation), transportation of “cuttings” (pieces of formation dislodged by the cutting action of the teeth on a drill bit) to the surface, controlling formation fluid pressure to prevent blowouts, maintaining well stability, suspending solids in the well, minimizing fluid loss into and stabilizing the formation through which the well is being drilled, fracturing the formation in the vicinity of the well, displacing the fluid within the well with another fluid, cleaning the well, testing the well, transmitting hydraulic horsepower to the drill bit, fluid used for emplacing a packer, abandoning the well or preparing the well for abandonment, and otherwise treating the well or the formation.

In many of these instances wellbore fluids with particular characteristics are may be needed in order to accomplish the desired goal. For example, a conductive wellbore fluid may be needed to effectively acquire a wireline well log, which can provide information about the geological composition of the downhole formation and/or the location of the drill bit during drilling. The information gleaned from a wireline well log may be used to inform the driller of the particular wellbore fluid composition (e.g., appropriate fluid components, weight, etc.) to implement in their downhole operations.

In general, drilling fluids should be pumpable under pressure down through strings of drilling pipe, then through and around the drilling bit head deep in the earth, and then returned back to the earth surface through an annulus between the outside of the drill stem and the hole wall or casing. Beyond providing drilling lubrication and efficiency, and retarding wear, drilling fluids should suspend and transport solid particles to the surface for screening out and disposal. In addition, the fluids should be capable of suspending additive weighting agents (to increase the specific gravity of the mud), generally finely ground barites (barium sulfate ore), and transporting clay and other substances capable of adhering to and coating the borehole surface.

Drilling fluids are generally characterized as thixotropic fluid systems. That is, they exhibit low viscosity when sheared, such as when in circulation (as occurs during pumping or contact with the moving drilling bit). However, when the shearing action is halted, the fluid should be capable of suspending the solids it contains to prevent gravity separation. In addition, when the drilling fluid is under shear conditions and a free-flowing near-liquid, it should retain a sufficiently high enough viscosity to carry unwanted particulate matter from the bottom of the wellbore to the surface. The drilling fluid formulation should also allow the cuttings and other unwanted particulate material to be removed or otherwise settle out from the liquid fraction.

There is an increasing need for drilling fluids having rheological profiles that enable wells to be drilled more easily. Drilling fluids having tailored rheological properties ensure that cuttings are removed from the wellbore as efficiently and effectively as possible to avoid the formation of cutting beds in the well which can cause the drill string to become stuck, among other issues. There is also the need from a drilling fluid hydraulics perspective (equivalent circulating density) to reduce the pressures required to circulate the fluid, this helps to avoid exposing the formation to excessive forces that can fracture the formation causing the fluid, and possibly the well, to be lost. In addition, an enhanced profile is necessary to prevent settlement or sag of the weighting agent in the fluid, if this occurs it can lead to an uneven density profile within the circulating fluid system which can result in well control (gas/fluid influx) and wellbore stability problems (caving/fractures).

To obtain the fluid characteristics that will help to meet these challenges, the fluid should be easy to pump so a minimum amount of pressure can force it through restrictions in the circulating fluid system, such as bit nozzles or down-hole tools. Or in other words, the fluid should have the lowest possible viscosity under high shear conditions. Conversely, in zones of the well where the area for fluid flow is large and the velocity of the fluid is slow or where there are low shear conditions, the viscosity of the fluid should be as high as possible in order to suspend and transport the drilled cuttings. This also applies to the periods when the fluid is left static in the hole, where both cuttings and weighting materials need to be kept suspended to prevent settlement. However, it should also be noted that the viscosity of the fluid should not continue to increase under static conditions to unacceptable levels. Otherwise when the fluid needs to be circulated again this can lead to excessive pressures that can fracture the formation or alternatively it can lead to lost time if the force required to regain a fully circulating fluid system is beyond the limits of the pumps.

Wellbore fluids may also contribute to the stability of the wellbore, and control the flow of gas, oil or water from the pores of the formation in order to prevent, for example, the flow or blow out of formation fluids or the collapse of pressured earth formations. The column of fluid in the hole exerts a hydrostatic pressure proportional to the depth of the hole and the density of the fluid. High-pressure formations may necessitate a fluid with a specific gravity as high as 3.0.

A variety of materials are presently used to increase the density of wellbore fluids. These include dissolved salts such as sodium chloride, calcium chloride and calcium bromide. In some embodiments, powdered minerals such as barite, calcite and hematite are added to a fluid to form a suspension of increased density. The use of finely divided metal, such as iron, as a weight material in a drilling fluid wherein the weight material includes iron/steel ball-shaped particles having a diameter less than 250 microns and in many instances between 15 and 75 microns has also been described. The use of finely powdered calcium or iron carbonate has also been proposed; however, the plastic viscosity of such fluids rapidly increases as the particle size decreases, limiting the utility of these materials.

One condition of these wellbore fluid additives is that they form a stable suspension and do not readily settle out. A second condition is that the suspension exhibit a low viscosity in order to facilitate pumping and to minimize the generation of high pressures. Finally, the wellbore fluid slurry should also exhibit low fluid loss.

Conventional weighting agents such as powdered barite exhibit an average particle diameter (d₅₀) in the range of 10-30 μm. To adequately suspend these materials may involve the addition of a gellant such as bentonite for water-based fluids, or organically modified bentonite for oil-based fluids. A soluble polymer viscosifier such as xanthan gum may be also added to slow the rate of the sedimentation of the weighting agent. However, as more gellant is added to increase the suspension stability, the fluid viscosity (plastic viscosity and/or yield point) increases undesirably resulting in reduced pumpability. This is also the case if a viscosifier is used to maintain a desirable level of solids suspension.

The sedimentation (or “sag”) of particulate weighting agents becomes more detrimental in wellbores drilled at high angles from the vertical, in that a sag of, for example, one inch (2.54 cm) can result in a continuous column of reduced density fluid along the upper portion of the wellbore wall. Such high angle wells are frequently drilled over large distances in order to access, for example, remote portions of an oil reservoir. In such instances it is important to minimize a drilling fluid's plastic viscosity in order to reduce the pressure losses over the borehole length. At the same time a high density also should be maintained to prevent a blow out. Further, as noted above with particulate weighting materials the issues of sag become increasingly important to avoid differential sticking or the settling out of the particulate weighting agents on the low side of the wellbore.

Being able to formulate a drilling fluid having a high density and a low plastic viscosity is also important in deep high pressure wells where high-density wellbore fluids are often needed. High viscosities can result in an increase in pressure at the bottom of the hole under pumping conditions. This increase in “Equivalent Circulating Density” (ECD) can result in opening fractures in the formation, and serious losses of the wellbore fluid into the fractured formation. Again the stability of the suspension is important in order to maintain the hydrostatic head to avoid a blow out.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to methods of formulating wellbore fluids, where the method includes providing a base fluid and adding a weighting agent coated with a conductive material.

In another aspect, embodiments disclosed herein relate to wellbore fluids including a base fluid and a conductive weighting agent.

In a further aspect, embodiments disclosed herein relate to a method of drilling a wellbore, where the method includes drilling at least a section of a wellbore using a wellbore fluid with a conductive weighting agent.

Other aspects and advantages of the claimed subject matter will be apparent from the following description and the appended claims.

### BRIEF DESCRIPTION OF DRAWINGS

FIG. 1 depicts an embodiment for producing a coated weighting agent.

### DETAILED DESCRIPTION

In one aspect, embodiments disclosed herein relate to conductive coatings on weighting agents used in wellbore fluids. In another aspect, embodiments disclosed herein relate to wellbore fluids, and the formulation and use of, that include conductive polymer coated weighting agents. In one or more embodiments, a conductive coating on weighting agents used in a conventionally non-conducting wellbore fluid (i.e., oil-based muds or invert emulsion fluids) may facilitate the acquisition of electrical logs using a wireline logging tool or resistivity logs using logging while drilling tool during or after drilling a formation.

Weighting Agents

Weighting agents used in embodiments disclosed herein may include a variety of compounds well known to one of skill in the art. In a particular embodiment, the weighting agent may be selected from materials including, for example, barium sulphate (barite), calcium carbonate, dolomite, ilmenite, hematite, olivine, siderite, manganese oxide, and strontium sulphate. One having ordinary skill in the art would recognize that selection of a particular material may depend largely on the density of the material as typically, the lowest wellbore fluid viscosity at any particular density is obtained by using the highest density particles. However, other considerations may influence the choice of product such as cost, local availability, and whether the residual solids or filter cake may be readily removed from the well.

The source of conventional weighting agents, such as barite, is mined ore, which may be subjected to comminution (grinding) processes to produce particles having the desired particle size. Various particle sizes are used in downhole operations, including those of the present disclosure, may range, for example, from API-grade barite (d₉₀≈70 microns) to a micronized barite (d₉₀=1-25 microns). In one embodiment of the present application, the weighting agent may be a sized weighting agent having a d₉₀ ranging from 1 to 25 μm and a d₅₀ ranging from 0.5 to 10 μm. In another embodiment, the sized weighting agent includes particles having a d₉₀ ranging from 2 to 8 μm and a d₅₀ ranging from 0.5 to 4 μm. One of ordinary skill in the art would recognize that, depending on the sizing technique, the weighting agent may have a particle size distribution other than a monomodal distribution. That is, the weighting agent may have a particle size distribution that, in various embodiments, may be monomodal, which may or may not be Gaussian, bimodal, or polymodal.

Particles having these size distributions may be obtained by several means. For example, sized particles, such as a suitable barite product having similar particle size distributions as disclosed herein, may be commercially purchased. A coarser ground suitable material may be obtained, and the material may be further ground by any known technique to the desired particle size. Such techniques include various milling processes such as pin-milling, jet-milling, high performance dry milling techniques, or any other technique that is known in the art generally for milling powdered products. Further, such milling processes may also (or instead) be used to coat the weighting agents in accordance with embodiments of the present disclosure. For example, a pin mill may operate by providing a high degree of shear from two counter rotating disks of pins, and polymer may be sprayed through the nozzles placed within the disks. The high shear action may be very effective in dispersing the particles of the powder and thus allowing an effective and uniformly dispersed coating action from the polymer. This is done in a continuous process and the powder is coated within seconds. Depending on the size of the particles, the particles could be smaller than the milling capabilities of the pin mill so the pins may act to de-agglomerate the particles and provide shear in a continuous process.

In one embodiment, appropriately sized particles of barite may be selectively removed from a product stream of a conventional barite grinding plant, which may include selectively removing the fines from a conventional API barite grinding operation. Fines are often considered a by-product of the grinding process, and conventionally these materials are blended with courser materials to achieve API grade barite. However, in accordance with the present disclosure, these by-product fines may be further processed via an air classifier to achieve the particle size distributions disclosed herein.

In yet another embodiment, the weighting agents may be formed by chemical precipitation. Such precipitated products may be used alone or in combination with mechanically milled products. Embodiments of the present disclosure provide for an alternative source of such weighting agents, by precipitation, which may also allow for a broader range of attainable particle sizes. In some embodiments, precipitation may be used to obtain particle sizes that are smaller than those capable of being reliably produced by grinding techniques. As used herein, the term “precipitated weighting agents” refers to weighting agents formed synthetically from a solution by chemical precipitation, as compared to conventional weighting agents formed naturally and mined as a crude material and may be referred to as a primary mineral. “Primary minerals” such as primary barite, refers to the first marketable product, which include crude minerals as well as the products of simple beneficiation methods, such as washing, jigging, heavy media separation, tabling, flotation, and magnetic separation. However, for use in wells, the minerals are also crushed/ground and screened.

Precipitated weighting agents used in some embodiments disclosed herein may include a variety of precipitated forms of the typical weighting agent compounds known to one of skill in the art, which may include, for example, barium sulfate (barite), calcium carbonate (calcite), magnesium carbonate (magnesite), calcium magnesium carbonate (dolomite), iron oxide (hematite), magnesium and iron silicate (olivine), iron carbonate (siderite), and strontium sulfate (celestine). Additionally, as the precipitated weighting agents of the present disclosure are synthetically produced, one of ordinary skill in the art would appreciate that compounds other than those naturally formed as mineral ores may be formed by precipitation and used as weighting agents in the fluids of the present disclosure. Thus, in one embodiment, various sulfates, carbonates, silicates, phosphates, aluminosilicates, oxides, etc. of various metals and/or alkaline earth metals including, for example, calcium, barium, magnesium, iron, strontium, aluminum, and/or zinc, may be used. Further, while many alkali salts, such as sodium are fairly soluble, others, such as sodium aluminosilicate and/or sodium magnesium aluminosilicate, are fairly insoluble and thus may be used as alternative precipitated weighting agents in the fluids of the present disclosure.

In some embodiments, the precipitated weighting agent may be formed of particles that are composed of a material of specific gravity of at least 1.8; at least 2.3 in other embodiments; at least 2.4 in other embodiments; at least 2.5 in other embodiments; at least 2.6 in other embodiments; and at least 2.68 in yet other embodiments. For example, a weighting agent formed of particles having a specific gravity of at least 2.68 may allow wellbore fluids to be formulated to meet most density requirements yet have a particulate volume fraction low enough for the fluid to be pumpable.

In some embodiments, the average particle size (d₅₀) of the precipitated (or ground) weighting agents may range from a lower limit of greater than 5 nm, 10 nm, 30 nm, 50 nm, 100 nm, 200 nm, 500 nm, 700 nm, 1 micron, 1.2 microns, 1.5 microns to an upper limit of less than 30 microns, 25 microns, 20 microns, 10 microns, 5 microns, 2.5 microns, 1.5 microns, 1 micron, 700 nm, 500 nm, 100 nm, where the particles may range from any lower limit to any upper limit. In other embodiments, the d₉₀ (the size at which 90% of the particles are smaller) of the precipitated (or ground) weighting agents may range from a lower limit of greater than 20 nm, 50 nm, 100 nm, 200 nm, 500 nm, 700 nm, 1 micron, 1.2 microns, 1.5 microns, 3 microns, 5 microns to an upper limit of less than 80 microns, 70 microns, 50 microns, 35 microns, 30 microns, 25 microns, 15 microns, 10 microns, 5 microns, 2.5 microns, 1.5 microns, 1 micron, 700 nm, 500 nm, where the particles may range from any lower limit to any upper limit.

Further, one of ordinary skill in the art would recognize that the precipitated weighting agents may have a particle size distribution other than a monomodal distribution. That is, the weighting agent may have a particle size distribution that, in various embodiments, may be monomodal, which may or may not be Gaussian, bimodal, or polymodal.

In one or more embodiments, particles having these average particle sizes may be obtained by chemical precipitation, whereby insoluble solid weighting agents are produced as a result of a chemical reaction between chemical species in a solution. Precipitation occurs following the mixing of at least two chemical specific in solution. One of ordinary skill in the art would appreciate that the chemical identity of those chemicals mixed would depend on the desired resulting compound to be used as a weighting agent. For example, when a barium sulfate weighting agent is desired, a barium salt solution (e.g., barium hydroxide, barium chloride, etc) may be mixed with an alkali sulfate salt solution (e.g., sodium sulfate, sulfuric acid) to precipitate barium sulfate. However, where a carbonate, such as calcium carbonate is desired, a calcium hydroxide solution combined with carbon dioxide results in the formation of calcium carbonate. Other sulfates and carbonates may be similarly formed by replacing the alkaline metal salt solution with another alkaline metal (or other metal) salt solution, while silicates may be formed by replacing sulfate salt solution with a silicate salt solution, such as sodium silicate). Further, for precipitation of other compounds such as ferric oxide, ferric oxide may be precipitated from an iron salt solution by exposing the solution to elevated temperatures and pressures to hydrolyze the iron in solution and precipitate out.

Mixing may occur, for example, in stirred tank reactors (batch or continuous), static or rotor-stator mixers. Devices in which the rotor rotates at a high speed (such as at least 120000 rpm are particularly suitable for use in forming such precipitated weighting agents because the shear, transverse, and frictional forces of intermeshing tools (in combination with high speeds) may result in the formation of fine, dispersed particles. Additional techniques such as the application of impinging jets, micro-channel mixers, or the use of a Taylor-Couette reactor may improve the mixing intensity and result in smaller particles and better particle homogeneity. In some embodiments, ultrasonication, which may provide higher shear and stirring energy to induce micromixing and dissipate high power locally, may also provide smaller particles and better particle homogeneity by allowing for control of various parameters, such as power input, reactor design, residence time, particle, or reactant concentration independently. After the solution has passed through the mixer, the resulting precipitated weighting agents may be separated out and dried for later use in a wellbore fluid.

Conductive Materials

In one or more embodiments, the conductive coatings on the weighting agents may be a conductive polymer. Conductive polymers, also sometimes referred to as intrinsically conducting polymers, are organic polymers that conduct electricity. Their conductivity may be of a metallic or semiconductive type. Conductive polymers may have a main polymer chain or “backbone” that contains aromatic cycles and/or double carbon-carbon bonds. In some embodiments, the conductive polymers may have a main polymer chain that contains a repeating unit including an aromatic cycle such as polyfluorenes, polyphenylenes, polyphenylene sulfides, polypyrenes, polyazulenes, polynaphthalenes, polypyrroles, polycarbazoles, polyindoles, polyazepines, polyanilines, polythiophenes, poly(3,4-ethylenedioxythiophene), and poly(p-phenylene sulfide). In one or more embodiments, the conductive polymers may have a main polymer chain that contains a repeating unit including a double carbon-carbon bond such as polyacetylenes. In other embodiments, the conductive polymers may have a main polymer chain that contains a repeating unit including both an aromatic cycle and a double carbon-carbon bond such as, poly(p-phenylene vinylene).

In one embodiment, when using a dry or wet blending/coating process the conductive polymer may comprise from about 1% to about 10% of the total mass of the conductive polymer plus weighting agent.

Coating Process by Grinding

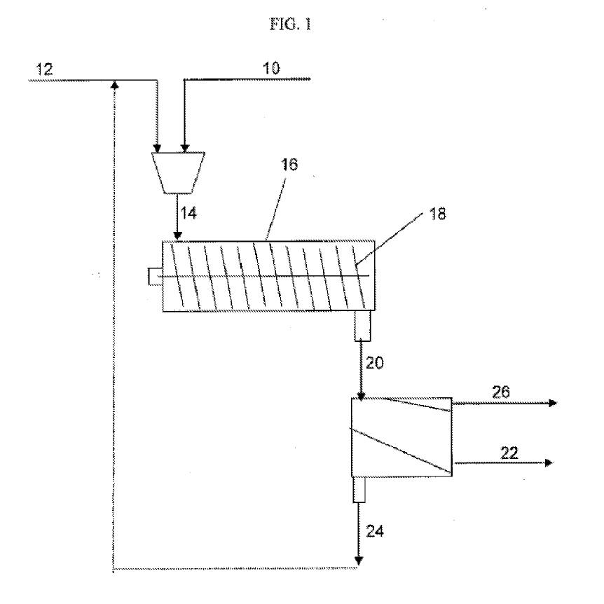

In some embodiments, coating of the weighting agent (precipitated or naturally occurring) with the conductive polymer may be performed in a dry blending process such that the process is substantially free of solvent. In other embodiments, the coating of the weighting agent may be performed in the presence of a solvent, such as the base fluid used in the wellbore fluid formulation or a solvent compatible with the base fluid. With reference to FIG. 1, one embodiment for producing a coated weighting agent is illustrated. The process includes blending the weighting agent 10 and a conductive polymer 12 at a desired ratio to form a blended material. In one embodiment, the weighting agent 10 may be unsized initially and rely on the blending process to grind the particles into the desired size range as disclosed above. In another embodiment, the process may begin with sized weighting agents. The blended material 14 may then be fed to a heat exchange system 16, such as a thermal desorption system. The mixture may be forwarded through the heat exchanger using a mixer 18, such as a screw conveyor. Upon cooling, the conductive polymer may remain associated with the weighting agent. The polymer/weighting agent mixture 20 may then be separated into conductive polymer coated weighting agent 22, unassociated conductive polymer 24, and any agglomerates 26 that may have formed. The unassociated conductive polymer 24 may optionally be recycled to the beginning of the process, if desired. In another embodiment, the dry blending process alone may serve to coat the weighting agent without heating.

In some embodiments, a sized weighting agent may be coated with a conductive polymer by thermal adsorption as described above, in the absence of a dry blending process. In this embodiment, a process for making a coated substrate may include heating a sized weighting agent to a temperature sufficient to react a monomer of a conductive polymer as described above onto the weighting agent to form a polymer coated sized weighting agent and recover the conductive polymer coated weighting agent. In another embodiment, one may use a catalyzed process to form the conductive polymer in the presence of the sized weighting agent. In yet another embodiment, the conductive polymer may be pre-formed and may be thermally adsorbed onto the sized weighting agent via a thermal process.

According to yet another embodiment, the conductive polymer is coated onto the weighting agent during the dry grinding process (wet or dry grinding in various embodiments). That is to say, coarse weighting agent is ground in the presence of a relatively high concentration of conductive polymer such that the newly formed surfaces of the fine particles are exposed to and thus coated by the conductive polymer. It is speculated that this allows the conductive polymer to find an acceptable conformation on the particle surface thus coating the surface. Additionally, it is speculated that because there is a relatively higher concentration of conductive polymer in the grinding fluid, as opposed to that in a drilling fluid having both weighting agent and conductive polymer, the conductive polymer is more likely to be adsorbed (either physically or chemically) to the particle surface during the grinding process. As is used herein, “coating of the surface” is intended to mean that a sufficient number of conductive polymer molecules are adsorbed (physically or chemically) or otherwise closely associated with the surface of the particles so that the fine particles of material do not cause the rapid rise in viscosity previously observed. By using such a definition, one of skill in the art should understand and appreciate that the conductive polymer molecules may not actually be fully covering the particle surface and that quantification of the number of molecules is very difficult.

Further, one of ordinary skill in the art would appreciate that dry coated particles may be obtained from an oil-based slurry through methods such as spray drying and thermal desorption, for example.

In some embodiments, coating of the weighting agent with the conductive polymer may be performed in a wet blending process. For example, a weighting agent and a conductive polymer may be blended in a liquid medium at a desired ratio to form a blended material. In some embodiments, the liquid medium is an oleaginous fluid including diesel oil, mineral or white oils, n-alkanes or synthetic oils such as alpha-olefin oils, ester oils or poly(alpha-olefins), as well as combinations and mixtures of these and similar fluids which should be known to one of skill in the art. During a wet blending process the weighting agent may be ground to a particular size during the blending process. However, in other embodiments the weighting agent may maintain substantially the same size during the wet blending process.

Coating Process by Precipitation

As discussed above, fluids used in embodiments disclosed herein may include precipitated weighting agents having a conductive polymer coating on its surface. The coating of the surface of the precipitated weighting agents may occur during the precipitation, after the precipitation, or both during and after the precipitation. As that term is used in herein, “coating of the surface” is intended to mean that a sufficient number of dispersant molecules are absorbed (physically or chemically) or otherwise closely associated with the surface of the particles so that the fine particles of material disperse into a fluid without forming agglomerates, which may cause a rapid rise in viscosity. By using such a definition, one of skill in the art should understand and appreciate that the conductive polymer molecules may not actually be fully covering the particle surface and that quantification of the number of molecules is very difficult. Therefore, by necessity, reliance is made on a results oriented definition. As a result of the process, one can control the colloidal interactions of the fine particles by coating the particle with conductive polymers prior to addition to the drilling fluid. By doing so, it may be possible to systematically control the rheological properties of fluids containing the additive as well as the tolerance to contaminants in the fluid in addition to enhancing the fluid loss (filtration) properties of the fluid.

In some embodiments, the precipitated weighting agents include solid colloidal particles having conductive polymers coated onto the surface of the particle. The size of the precipitated particles may allow for high density suspensions or slurries that show a reduced tendency to sediment or sag, while the conductive polymer on the surface of the particle may help to control inter-particle interactions resulting in lower rheological profiles and, once formulated into a fluid, the conductive polymer coated weighting agents may provide for conductive properties within the fluid itself

In some embodiments, the weighting agents include dispersed solid colloidal particles with a weight average particle diameter (d₅₀) of less than 10 microns that are coated with a conductive polymer. In other embodiments, the weighting agents include dispersed solid colloidal particles with a weight average particle diameter (d₅₀) of less than 8 microns that are coated with a conductive polymer; less than 6 microns in other embodiments; less than 4 microns in other embodiments; and less than 2 microns in yet other embodiments. The fine particle size may generate suspensions or slurries that will show a reduced tendency to sediment or sag, and the polymeric agent on the surface of the particle may control the inter-particle interactions.

Coating of the precipitated weighting agent with the conductive polymer may be achieved by adding the conductive polymer to the solution prior to mixing. Thus, as mixing and precipitation occurs, the particles are coated. The presence of the conductive polymer during the mixing and precipitation may also provide for inhibition of grain growth of the particles if ultra-fine or nano-sized weighting agents are desired, and also prevention of particle agglomeration.

Coating of the precipitated weighting agent with the conductive polymer may also be performed in a wet or dry blending process following precipitation, where in a dry blending process the process may be substantially free of solvent. The wet or dry processes may include blending the precipitated weighting agent and a conductive polymer at a desired ratio to form a blended material. The blended material may then be fed to a heat exchange system, such as a thermal desorption system. The mixture may be forwarded through the heat exchanger using a mixer, such as a screw conveyor. Upon cooling, the polymer may remain associated with the weighting agent. The polymer/weighting agent mixture may then be separated into polymer coated weighting agent, unassociated polymer, and any agglomerates that may have formed. The unassociated polymer may optionally be recycled to the beginning of the process, if desired. In another embodiment, the dry blending process alone may serve to coat the weighting agent without heating.

In some embodiments, a precipitated weighting agent may be coated by thermal adsorption as described above, in the absence of a wet or dry blending process. In one or more embodiments (including, but not limited to thermal adsorption), a process for making a coated substrate may include heating a ground or precipitated weighting agent to a temperature sufficient to react monomeric conductive polymer onto the weighting agent to form a polymer coated weighting agent and recovering the polymer coated weighting agent. In another embodiment, one may use a catalyzed process to form the polymer in the presence of the weighting agent. In yet another embodiment, the polymer may be pre-formed and may be thermally adsorbed onto the weighting agent. Further, it is specifically within the scope of the embodiments disclosed herein that the conductive polymer be polymerized prior to or simultaneously with the wet or dry blending processes disclosed herein. Such polymerizations may involve, for example, thermal polymerization, catalyzed polymerization, initiated polymerization or combinations thereof. In one or more embodiments, the polymerization may be an oxidative polymerization of a monomer. For example, an aniline monomer may be polymerized in the presence of a ground or precipitated weight agent, such as barite. In some embodiments, the present disclosure pertains to methods of making the compositions of the present disclosure. In some embodiments, the method involves coating a weighting material (e.g., barite) with an electrically conductive polymer. In some embodiments, the coating step includes: (1) mixing the weighting material with a monomer; and (2) polymerizing the monomer in the presence of the weighting material. In some embodiments, the coating may also be reduced, sulfonated and/or carbonized. In some embodiments, the method also involves a self-doping step. In some embodiments, the methods of the present disclosure do not involve the use of surfactants, additional phases, or barium sulfate synthesis by precipitation from barium chloride. In some embodiments that aim to preserve conductivity in a basic environment, a monomer coating (e.g., an aniline coating) is first reduced to the leucoemeraldine oxidation state and subsequently sulfonated with fuming sulfuric acid. In one or more embodiments, the sulfonation agent may include, without limitation, fluorosulfonic acid, acetyl sulfate, gaseous sulfur trioxide, and combinations thereof Adsorbed polymer may be self-doped to allow pH-stable conductivity. In one or more embodiments, the self-doping technique may involve reaction with carboxylic acid enolates, mercaptoalkyl sulfonic acids, N-alkylation, and phosphites.

Other Conductive Materials

In one or more embodiments, the conductive coating on the weighting agent may be a chemically converted grapheme. Thus, the present disclosure may also pertain to methods of making hybrid materials that contain at least one chemically converted graphene and at least one weighting agent (inorganic mineral). In some embodiments, the method includes associating a graphene material (e.g., graphene oxide or graphene oxide nanoribbons) with an inorganic mineral (e.g., mineral particles, barite, calcium carbonate, and combinations thereof). In some embodiments, the methods of the present disclosure also include a step of reducing the graphene material to chemically converted graphene (CCG).

The methods of the present disclosure may utilize various types of graphene materials. For instance, in some embodiments, the graphene materials include, without limitation, graphene oxide (GO), graphene oxide nanoribbons (GONRs), and combinations thereof. In some embodiments, the graphene materials may be functionalized. In some embodiments, the graphene materials may be functionalized with a plurality of oxygenated functional groups. In some embodiments, the oxygenated functional groups include, without limitation, carboxyl groups, carbonyl groups, epoxy groups, hydroxyl groups, and combinations thereof.

The methods of the present disclosure may also utilize various types of inorganic minerals, such as those described above. In some embodiments, the inorganic minerals include, without limitation, clays, carbonates, sulfates, hydroxides, oxides, hydroxyapatites, carbonates, alumosilicates, and combinations thereof. In some embodiments, the inorganic minerals are in the form of particles. In some embodiments, the inorganic mineral particles are in the form of spheres. In some embodiments, the inorganic minerals are conductive.

Various methods may also be utilized to associate graphene materials with inorganic minerals. In some embodiments, the association occurs by mixing graphene materials with inorganic minerals in a solution (e.g., an aqueous solution). In some embodiments, the mixing occurs by deposition of graphene materials in an aqueous phase containing inorganic minerals via a one-pot solution process. In some embodiments, the association results in the self-assembly of the graphene materials with the inorganic minerals. In some embodiments, the association results in the adsorption of the graphene materials onto the inorganic minerals. In some embodiments, the mixing results in the immobilization of the graphene materials on a surface of inorganic minerals (e.g., conductive mineral particles containing barite, calcium carbonate (CaCO₃), and combinations thereof).

Various methods may also be utilized to reduce graphene materials to chemically converted graphene (CCG). In some embodiments, the reduction occurs after the association of graphene materials with inorganic minerals. In some embodiments, the reduction occurs by exposing the graphene materials to a reducing agent. In some embodiments, the reducing agent includes, without limitation, hydroxylamine, organic amines, formaldehyde, L-ascorbic acid, hydrazine hydrate, NaHSO₃, Na₂SO₃, Na₂S₂O₃, Na₂S, and combinations thereof. In some embodiments, the reduction can occur by heating a solution that contains the graphene material (e.g., heating to temperatures greater than 190° C.).

The methods of the present disclosure can also include a step of tuning the electrical properties of the hybrid materials. In some embodiments, the electrical properties or conductivity of the hybrid materials can be tuned by controlling the amount of graphene materials or chemically converted graphene that become associated with inorganic minerals.

The methods of the present disclosure can be utilized to make various types of hybrid materials that contain at least one chemically converted graphene and at least one inorganic mineral (as previously described). Additional embodiments of the present disclosure pertain to such hybrid materials. In some embodiments, the hybrid materials are in the form of homogeneous core-shell structures. In some embodiments, the hybrid materials of the present disclosure are electrically conductive. In some embodiments, the hybrid materials of the present disclosure have tunable electrical properties. In some embodiments, the hybrid materials of the present disclosure include, without limitation, electrically conductive barite/CCG, electrically conductive calcium carbonate/CCG, and combinations thereof

In some embodiments, the conductive hybrid materials of the present disclosure can be synthesized via a one-pot process. In some embodiments, the one-pot process occurs when inorganic mineral particles (e.g., barite or calcium carbonate) are dispersed in a water and mixed with an aqueous solution of GO or GONR and then reduced with hydrazine hydrate. Thus, in some embodiments, conductive powders based on barite and calcium carbonate can be synthesized by a solution process consisting of adsorption of graphene oxide (GO) or graphene oxide nanoribbons (GONRs) in aqueous phase and its subsequent chemical reduction. Efficient adsorption of GO or GONRs on the surface of the mineral particles may take place resulting in the obtaining of graphene-wrapped hybrid materials. Both barite-based and calcium-carbonate based hybrid systems may demonstrate concentration-dependent electrical conductivity, which increases with GO or GONR content.

Fluid Formulation

Given the particulate nature of the conductive coated weighting agents disclosed herein, one of skill in the art should appreciate that additional components may be mixed with the weighting agent to modify various macroscopic properties. For example, anti-caking agents, lubricating agents, and agents used to mitigate moisture build-up may be included. In some embodiments, solid materials that enhance lubricity or help control fluid loss may be added to the weighting agents and drilling fluid disclosed herein. In one illustrative example, finely powdered natural graphite, petroleum coke, graphitized carbon, or mixtures of these are added to enhance lubricity, rate of penetration, and fluid loss as well as other properties of the drilling fluid. Another illustrative embodiment utilizes finely ground polymeric materials to impart various characteristics to the drilling fluid. In instances where such materials are added, it is important to note that the volume of added material should not have a substantial adverse impact on the properties and performance of the drilling fluids. In one illustrative embodiment, polymeric fluid loss materials comprising less than 5 percent by weight are added to enhance the properties of the drilling fluid. In some embodiments, less than 5 percent by weight of suitably sized graphite and petroleum coke are added to enhance the lubricity and fluid loss properties of the fluid. Finally, in another illustrative embodiment, less than 5 percent by weight of a conventional anti-caking agent is added to assist in the bulk storage of the weighting materials.

The conductive coated weighting agents described herein may be added to a drilling fluid as a weighting agent in a dry form or concentrated as slurry in either an aqueous medium or as an organic liquid. As is known, an organic liquid should have the necessary environmental characteristics for additives to oil-based drilling fluids. With this in mind, the oleaginous fluid may have a kinematic viscosity of less than 10 centistokes (10 mm²/s) at 40° C. and, for safety reasons, a flash point of greater than 60° C. Suitable oleaginous liquids are, for example, diesel oil, mineral or white oils, n-alkanes or synthetic oils such as alpha-olefin oils, ester oils, mixtures of these fluids, as well as other similar fluids known to one of skill in the art of drilling or other wellbore fluid formulation.

Use in Wellbore Formulations.

The coated weighting agent particles described above may be used in any wellbore fluid such as drilling, cementing, completion, packing, work-over (repairing), stimulation, well killing, spacer fluids, and other applications using high density fluids, such as in a dense media separating fluid or in a ship's or other vehicle's ballast fluid. Such alternative uses, as well as other uses, of the present fluid should be apparent to one of skill in the art given the present disclosure. In accordance with one embodiment, the coated weighting agent may be used in a wellbore fluid formulation. The wellbore fluid may be a water-based fluid, an invert emulsion or an oil-based fluid.

Water-based wellbore fluids may have an aqueous fluid as the base liquid and a conductive coated weighting agent. The aqueous fluid may include at least one of fresh water, sea water, brine, mixtures of water and water-soluble organic compounds and mixtures thereof. For example, the aqueous fluid may be formulated with mixtures of desired salts in fresh water. Such salts may include, but are not limited to alkali metal chlorides, hydroxides, or carboxylates, for example. In various embodiments of the drilling fluid disclosed herein, the brine may include seawater, aqueous solutions wherein the salt concentration is less than that of sea water, or aqueous solutions wherein the salt concentration is greater than that of sea water. Salts that may be found in seawater include, but are not limited to, sodium, calcium, sulfur, aluminum, magnesium, potassium, strontium, silicon, lithium, and phosphorus salts of chlorides, bromides, carbonates, iodides, chlorates, bromates, formates, nitrates, oxides, and fluorides. Salts that may be incorporated in a brine include any one or more of those present in natural seawater or any other organic or inorganic dissolved salts. Additionally, brines that may be used in the drilling fluids disclosed herein may be natural or synthetic, with synthetic brines tending to be much simpler in constitution. In one embodiment, the density of the drilling fluid may be controlled by increasing the salt concentration in the brine (up to saturation). In a particular embodiment, a brine may include halide or carboxylate salts of mono- or divalent cations of metals, such as cesium, potassium, calcium, zinc, and/or sodium.

The oil-based/invert emulsion wellbore fluids may include an oleaginous continuous phase, a non-oleaginous discontinuous phase, and a conductive coated weighting agent. The oleaginous fluid may be a liquid, in some embodiments a natural or synthetic oil, and in more specific embodiments the oleaginous fluid is selected from the group including diesel oil; mineral oil; a synthetic oil, such as hydrogenated and unhydrogenated olefins including polyalpha olefins, linear and branch olefins and the like, polydiorganosiloxanes, siloxanes, or organosiloxanes, esters of fatty acids, specifically straight chain, branched and cyclical alkyl ethers of fatty acids; similar compounds known to one of skill in the art; and mixtures thereof The concentration of the oleaginous fluid should be sufficient so that an invert emulsion forms and may be less than about 99% by volume of the invert emulsion. In one embodiment, the amount of oleaginous fluid is from about 30% to about 95% by volume and more particularly about 40% to about 90% by volume of the invert emulsion fluid. The oleaginous fluid, in one embodiment, may include at least 5% by volume of a material selected from the group including esters, ethers, acetals, dialkylcarbonates, hydrocarbons, and combinations thereof.

The non-oleaginous fluid used in the formulation of the invert emulsion fluid disclosed herein is a liquid and may be an aqueous liquid. In one embodiment, the non-oleaginous liquid may be selected from the group including sea water, a brine containing organic and/or inorganic dissolved salts, liquids containing water-miscible organic compounds, and combinations thereof. The amount of the non-oleaginous fluid is typically less than the theoretical limit needed for forming an invert emulsion. Thus, in one embodiment, the amount of non-oleaginous fluid is less than about 70% by volume, and particularly from about 1% to about 70% by volume. In another embodiment, the non-oleaginous fluid is from about 5% to about 60% by volume of the invert emulsion fluid. The fluid phase may include either an aqueous fluid or an oleaginous fluid, or mixtures thereof. In a particular embodiment, coated barite or other coated weighting agents may be included in a wellbore fluid having an aqueous fluid that includes at least one of fresh water, sea water, brine, and combinations thereof.

Conventional methods can be used to prepare the drilling fluids disclosed herein in a manner analogous to those normally used, to prepare conventional water- and oil-based drilling fluids. In one embodiment, a desired quantity of water-based fluid and a suitable amount of one or more conductive coated weighting agents, as described above, are mixed together and the remaining components of the drilling fluid added sequentially with continuous mixing. In another embodiment, a desired quantity of oleaginous fluid such as a base oil, a non-oleaginous fluid, and a suitable amount of one or more conductive coated weighting agents are mixed together and the remaining components are added sequentially with continuous mixing. An invert emulsion may be formed by vigorously agitating, mixing, or shearing the oleaginous fluid and the non-oleaginous fluid.

In yet another embodiment, the conductive coated products of the present disclosure may be used alone or in combination with conventional mechanically milled weighting agents that may also be coated with a conductive material, as discussed above. Other additives that may be included in the wellbore fluids disclosed herein include, for example, wetting agents, organophilic clays, viscosifiers, fluid loss control agents, surfactants, dispersants, interfacial tension reducers, pH buffers, mutual solvents, thinners, thinning agents, and cleaning agents. The addition of such agents should be well known to one of ordinary skill in the art of formulating drilling fluids and muds.

Application of Conductive Coated Weighting Agents

Outside of creating/increasing the depth of a well, a secondary objective in drilling a well is also to secure the maximum amount of information about the type of formations being penetrated and the type of fluids or gases in the formation. This information is obtained by analyzing the cuttings and by electrical logging technology and by the use of various downhole logging techniques, including electrical measurements.

The use of wireline well logs is well known in the art of drilling subterranean wells and in particular oil and gas wells. A wireline log is generated by lowering a logging tool down the well on a wireline. The tool is slowly brought back to the surface and the instruments on the logging tool take measurements that characterize the formations penetrated by the well in addition to other important properties of the well. For example, during logging wireline logs may use measurements of relative resistivity of the formation to determine geological composition of the downhole formation. Also, during drilling, such resistivity measurements may be useful to determine the location of the drill bit to enhance geosteering capabilities and directional drilling control. Thus, electrical logs and other wireline log techniques are depended upon in the oil and gas exploration industry to determine the nature of the geology and the reservoir properties of the petroleum bearing formations penetrated by the well, as well as other properties of the drilling process (e.g., the location of the drill bit). Further, wireline well logs are often the only record of the formations penetrated by the well available for correlation amongst different wells in a particular field.

When an electrical wireline log is made of a well, electrodes on the well logging tool are in contact with wellbore fluid or filter cake and hence the formation rocks through which the well has penetrated. An electrical circuit is created and the resistance and other electrical properties of the circuit may be measured while the logging tool is retracted from the well. The measurement of resistivity requires the presence of a highly conductive path between the logging tool and the formation (i.e., through the well bore fluid). The resulting data is a measure of the electrical properties of the drilled formations versus the depth of the well. The results of such measurements may be interpreted to determine the presence or absence of petroleum or gas, the porosity of the formation rock, and other important properties of the well.

An alternative or supplement to wireline logging involves logging tools placed in a specialized drill collar housing and run in the drill string near the bit. This technique is known as logging-while-drilling (L WD) or formation-evaluation-while-drilling (FEWD). Measurements such as electrical resistivity may be thereby taken and stored down hole for later retrieval during a “tripping out” of the drill string, or transmitted to the surface via mud-pulse telemetry. Such techniques are known to one of skill in the art of well drilling and subterranean well logging.

Wellbore fluids may be classified according to the primary component of the continuous phase, which are predominantly one of aqueous (water-based) wellbore fluids and non-aqueous (oleaginous or oil-based) wellbore fluids. Although oil-based wellbore fluids are more expensive than water-based muds, they are more often used for drilling operations because of their operational advantage and superior technical performance when compared with water-based muds. Innovations in oil-based muds and wellbore fluids are of on-going importance with the development of environmentally friendly wellbore fluids and fluids having other special characteristics. Oil-based muds may offer advantages over water-based muds in many drilling situations.

In particular, oil based muds are known in the art to provide excellent shale inhibition, borehole stability, lubricity, thermal stability, tolerance of contamination, and ease of maintenance. However, oil-based muds and wellbore fluids also have some disadvantages. One disadvantage is that normal resistivity and self potential measurements cannot be taken when the well has been drilled with a conventional oil-based mud or wellbore fluid due to the non-conductive nature of the oil-based wellbore fluids and muds. Said another way, when invert emulsion fluids are used, any electrical path through the fluid is insulating due to the nonconductive nature of the external oil phase. This severely limits the amount and clarity of resistivity information that may be gathered from a wellbore using wireline logging.

Various logging and imaging operations are performed during the drilling operation, for example while drilling in the reservoir region of an oil/gas well in order to determine the type of formation and the material therein. Such information may be used to optimally locate the pay zone, i.e., where the reservoir is perforated in order to allow the inflow of hydrocarbons to the well bore. Some logging tools work on the basis of a resistivity contrast between the fluid in the wellbore (wellbore fluid) and that already in the formation. These are known as resistivity logging tools. Briefly, alternating current flows through the formation between two electrodes. Thus, the fluids in the path of the electric current are the formation fluids and the fluid that has penetrated the formation by way of filtration. The filtercake and filtrate result from filtration of the mud over a permeable medium (such as formation rock) under differential pressure.

Another example where fluid conductivity plays a part in the drilling operation is in directional drilling where signals produced at the drill assembly have to be transmitted through an electrically conductive medium to the control unit and/or mud telemetry unit further back on the drill string. In some instances, such resistivity measurements may be useful in geosteering and directional drilling control.

The use of resistivity logging tools is often limited to cases where a water-based wellbore fluid is used for the drilling operations because the low conductivity of the base oil in the case of oil/synthetic-base wellbore fluids precludes the use of resistivity tools in such fluids. The case is similarly true for invert emulsion wellbore fluids.

Thus, embodiments of methods disclosed herein include methods of logging a subterranean well and wellbore fluids useful in such methods. In some embodiments, the methods may include placing into the subterranean well wellbore fluids, including non-aqueous fluids such as invert emulsions. The wellbore fluids may include one or more conductive coated weighting agents of the present disclosure present in a concentration so as to permit or improve the electrical logging of the well by the increased electrical conductance of the wellbore fluid. Other embodiments include the drilling of a subterranean well with an oleaginous-based wellbore fluid described herein. In such embodiments, the oleaginous-based wellbore fluids of the present disclosure may be formulated so as to enable one to take electrical log measurements of the subterranean well, despite the naturally low conductivity of the fluid.

In some embodiments, during logging and while using wellbore fluids with conductive coated weighting agents as described herein, wireline logs may be used to take measurements of the relative resistivity of the formation. The measurements of relative resistivity of the formation may be used to determine geological composition of the downhole formation. Also, such resistivity measurements may be useful to determine the location of the drill bit to enhance geosteering capabilities and directional drilling control. In some embodiments, the wellbore fluids with conductive coated weighting agents disclosed herein may be used with drilling systems having a measurement-while-drilling (“MWD”) system. For example, drilling and formation data and parameters may be determined from various downhole measuring devices and may be transformed downhole into selected parameters of interest and then transferred by telemetry to the surface.

In other embodiments, the measurements may be stored downhole for subsequent retrieval, or they may be both transferred via telemetry to the surface and/or stored downhole. In some embodiments, measurements may be depth-correlated, using depth measurements made downhole for improving accuracy of the measurements and the parameters of interest. In additional embodiments, the measurements and/or parameters may be correlated with stored reference data for providing additional information pertaining to the drilling operations and the formation characteristics. Thus, the logging measurements may be used to determine the drill bit location relative to the desired drilling path and to adjust the drilling activity downhole. Thus, these electrical logs and other wireline log techniques may determine the nature of the geology and the reservoir properties of the petroleum bearing formations penetrated by the well, as well as other properties of the drilling process (e.g., the location of the drill bit).

Although only a few example embodiments have been described in detail above, those skilled in the art will readily appreciate that many modifications are possible in the example embodiments without materially departing from this disclosure. Accordingly, all such modifications are intended to be included within the scope of this disclosure as defined in the following claims.

What is claimed:

1. A method of formulating a wellbore fluid comprising:
providing a base fluid; and
adding a weighting agent coated with a conductive material.

2. The method of claim 1, wherein the weighting agent is at least one selected from, calcium carbonate, ilmenite, olivine, strontium sulfate, barium sulfate, magnesium carbonate, calcium magnesium carbonate, iron oxide, magnesium silicate, iron silicate, iron carbonate, and strontium carbonate.

3. The method of claim 1, wherein the weighting agent is coated with the conductive material by a dry or wet blending process.

4. The method of claim 1, wherein the weighting agent is a precipitated weighting agent.

5. The method of claim 4, wherein the precipitated weighting agent is coated with the conductive material simultaneously with precipitating the weighting agent.

6. The method of claim 4, wherein the precipitated weighting agent is coated with the conductive material after precipitating the weighting agent.

7. The method of claim 1, wherein the conductive material is a conductive polymer selected from polyfluorenes, polyphenylenes, polypyrenes, polyazulenes, polynaphthalenes, polypyrroles, polycarbazoles, polyindoles, polyazepines, polyanilines, polythiophenes, poly(3,4-ethylenedioxythiophene), poly(p-phenylene sulfide), polyacetylenes, and poly(p-phenylene vinylene).

8. The method of claim 1, wherein the base fluid is one selected from an oil-based fluid and an invert emulsion.

9. A wellbore fluid comprising:
a base fluid; and
a conductive weighting agent.

10. The wellbore fluid of claim 9, wherein the base fluid is one selected from an oil-based fluid and an invert emulsion.

11. The wellbore fluid of claim 9, wherein the conductive weighting agent is at least one selected from, calcium carbonate, ilmenite, olivine, strontium sulfate, barium sulfate, magnesium carbonate, calcium magnesium carbonate, iron oxide, magnesium silicate, iron silicate, iron carbonate, and strontium carbonate.

12. The wellbore fluid of claim 9, wherein the conductive weighting agent is coated with a conductive polymer, wherein the conductive polymer comprises at least one selected from polyfluorenes, polyphenylenes, polypyrenes, polyazulenes, polynaphthalenes, polypyrroles, polycarbazoles, polyindoles, polyazepines, polyanilines, polythiophenes, poly(3,4-ethylenedioxythiophene), poly(p-phenylene sulfide), polyacetylenes, and poly(p-phenylene vinylene).

13. The wellbore fluid of claim 9, wherein the conductive weighting agent is a precipitated weighting agent.

14. The wellbore fluid of claim 9, wherein the conductive weighting agent is a natural weighting agent.

15. A method of drilling a wellbore, comprising:
drilling at least a section of a wellbore using a wellbore fluid with a conductive weighting agent.

16. The method of claim 15, wherein the conductive weighting agent is coated with a conductive polymer selected from polyfluorenes, polyphenylenes, polypyrenes, polyazulenes, polynaphthalenes, polypyrroles, polycarbazoles, polyindoles, polyazepines, polyanilines, polythiophenes, poly(3,4-ethylenedioxythiophene), poly(p-phenylene sulfide), polyacetylenes, poly(p-phenylene vinylene), and combinations thereof.

17. The method of claim 15, wherein the conductive weighting agent is at least one selected from, calcium carbonate, ilmenite, olivine, strontium sulfate, barium sulfate, magnesium carbonate, calcium magnesium carbonate, iron oxide, magnesium silicate, iron silicate, iron carbonate, and strontium carbonate.

18. The method of claim 15, wherein the wellbore fluid has a base fluid selected from an oil-based fluid or an invert emulsion.

19. The method of claim 15, further comprising:
acquiring at least one of an electrical log or a resistivity log of the subterranean formation surrounding the section of a wellbore.

20. The method of claim 19, further comprising:
collecting the electrical log; and
refining a drill location based on the collected electrical log.
